(19) United States
(12) Patent Application Publication
(10) Pub. No.: US 2026/0050255 A1
(43) Pub. Date: Feb. 19, 2026

(54) SYSTEMS, METHODS, AND COMPUTER PROGRAM PRODUCTS FOR CONFIGURING AN ALARM MANAGEMENT SYSTEM

(71) Applicant: Honeywell International Inc., Charlotte, NC (US)

(72) Inventors: Srikant Srinivasan, Bangalore (IN); Shanmugapriya Kanagasabapathy, Bangalore (IN); Karthick Manoharan, Bangalore (IN); Senthilkumar Kumarasamy, Krishnagiri (IN); Sairam Krishna, Bangalore (IN)

(21) Appl. No.: 18/802,956

(22) Filed: Aug. 13, 2024

(51) Int. Cl. G05B 23/02

(52) U.S. Cl. CPC G05B 23/027; G05B 23/0221

(57) ABSTRACT

Systems, apparatuses, methods, and computer program products are provided herein. For example, a method may include identifying an alarm management system and a set of parameters corresponding to the alarm management system. In some embodiments, the set of parameters correspond types of changes to the alarm management system. In some embodiments, the method includes providing an interface via which a user can configure one or more management of change (MOC) workflows. In some embodiments, the method includes detecting at least one change to the alarm management system. In some embodiments, the method includes determining at least one type of change corresponding to the detected at least one change to the alarm system. In some embodiments, the method includes identifying an MOC workflow corresponding to the detected type of change. In some embodiments, the method includes generating one or more tasks corresponding to the identified at least one MOC workflow.

### TECHNOLOGICAL FIELD

Embodiments of the present disclosure relate generally to systems, apparatuses, methods, and computer program products for customizing management of change and auditing needs for industrial alarm management.

### BACKGROUND

Applicant has identified many technical challenges and difficulties associated with systems, methods, and computer program products for customizing alarm management systems. Through applied effort, ingenuity, and innovation, Applicant has solved problems related to systems, apparatuses, methods, and computer program products for customizing management of change and auditing needs for industrial alarm management.

### BRIEF SUMMARY

Various embodiments described herein relate to systems, apparatuses, methods, and computer program products for customizing alarm management systems.

In accordance with one aspect of the disclosure, a method is provided. In some embodiments, the method comprises identifying an alarm management system and a set of parameters corresponding to the alarm management system. In some embodiments, the set of parameters correspond to one or more types of changes to the alarm management system. In some embodiments, the method includes providing an interface via which a user can configure one or more management of change (MOC) workflows. In some embodiments, the method includes detecting at least one change to the alarm management system. In some embodiments, the method includes determining at least one type of change corresponding to the detected at least one change to the alarm system. In some embodiments, the method includes identifying at least one MOC workflow corresponding to the at least one type of change corresponding to the detected change. In some embodiments, the method includes generating one or more tasks corresponding to the identified at least one MOC workflow.

In some embodiments, the method further includes executing the generated one or more tasks corresponding to the at least one MOC workflow.

In some embodiments, the method further includes executing the generated one or more tasks by assigning one or more reviewers to the at least one MOC workflow corresponding to the determined at least one type of change corresponding to the detected change.

In some embodiments, the set of parameters includes one or more parameters directed towards one or more levels of review required with respect to the identified type of change corresponding to the detected at least one change to the alarm management system.

In some embodiments, the method further includes executing the generated one or more tasks comprises assigning one or more approvers to the at least one MOC workflow corresponding to the detected change to the alarm system.

In some embodiments, the set of parameters includes one or more parameters directed towards levels of approval required for the one or more types of changes to the alarm management system.

In some embodiments, the method further includes generating a combination of one or more reviewer tasks and one or more approver tasks.

In some embodiments, the method further includes receiving a rejection corresponding to each of a threshold number of the one or more reviewer tasks and the one or more approver tasks. In such embodiments, the method may further include canceling one or more additional tasks responsive to receiving a rejection corresponding to each of a threshold number of the one or more reviewer tasks and the one or more approver tasks.

In some embodiments, the method further includes generating the one or more tasks includes assigning the generated one or more tasks to a user. In such embodiments, the method may further include notifying the user that the generated at least one task is available for their interaction.

In some embodiments, the method further includes defining one or more change states which are supported by the alarm management system.

In some embodiments, the method further includes defining, for a given state, one or more next possible states. The next possible states may correspond to states which are achievable upon completion of one or more currently assigned tasks.

In some embodiments, the method further includes determining that the detected type of change corresponding to the change to the alarm management system is unknown.

In some embodiments, the method further includes recommending a potential type of change corresponding to the change of alarm management system based on historical change data.

In some embodiments, the method further includes predicting a time to completion for the at least one MOC workflow corresponding to the detected change to the alarm management system. The predicted time to completion for the at least one MOC workflow may be based on one or more previously completed MOC workflows.

In some embodiments, the method further includes generating one or more tasks corresponding to the MOC workflow by identifying an appropriate template of tasks corresponding to the at least one MOC workflow.

In some embodiments, the method further includes applying one or more tags to the determined at least one MOC workflow. The one or more tags may indicate at least one or more measurements to which the at least one MOC workflow corresponds.

In accordance with one aspect of the disclosure, a system is provided. In some embodiments, the system comprises memory and one or more processors communicatively coupled to the memory. In some embodiments, the one or more processors are configured to

In some embodiments, the one or more processors are configured to identify an alarm management system and a set of parameters corresponding to the alarm management system. In some embodiments, the set of parameters correspond to one or more types of changes to the alarm management system. In some embodiments, the one or more processors are configured to provide a platform via which a user can configure one or more management of change (MOC) workflows. In some embodiments, the one or more processors are configured to detect at least one change to the alarm management system. In some embodiments, the one or more processors are configured to determine at least one type of change corresponding to the detected at least one change to the alarm management system. In some embodiments, the one or more processors are configured to identify at least one MOC workflow corresponding to the at least one type of change. In some embodiments, the one or more processors are configured to generate one or more tasks corresponding to the identified at least one MOC workflow.

In some embodiments, the one or more processors are further configured to execute the generated one or more tasks corresponding to the identified at least one MOC workflow.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying an alarm management system and a set of parameters corresponding to the alarm management system. In some embodiments, the set of parameters correspond to one or more types of changes to the alarm management system. In some embodiments, the computer code, in execution with at least one processor, configures the computer program product for providing an interface via which a user can configure one or more management of change (MOC) workflows. In some embodiments, the computer code, in execution with at least one processor, configures the computer program product for detecting at least one change to the alarm management system. In some embodiments, the computer code, in execution with at least one processor, configures the computer program product for determining at least one type of change corresponding to the detected at least one change to the alarm management system. In some embodiments, the computer code, in execution with at least one processor, configures the computer program product for identifying at least one MOC workflow corresponding to the at least one type of change. In some embodiments, the computer code, in execution with at least one processor, configures the computer program product for generating one or more tasks corresponding to the identified at least one MOC workflow.

In some embodiments, the computer program code, in execution with at least one processor, configures the computer program product for executing the generated one or more tasks corresponding to the identified at least one MOC workflow.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates a flowchart of an example method in accordance with one or more embodiments of the present disclosure; and

FIG. 4 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with customizing alarm management systems. As would be understood by one skilled in the field to which this disclosure pertains, there are numerous example scenarios in which it may be desirable to customize management of change and auditing needs for industrial alarm management systems.

Alarm systems are intended to provide an operator with pre-warning to an abnormal situation that requires their attention to avoid a potential incident. Abnormal situations continue to plague the process industries, such that billions of dollars are lost to both abnormal situations and the insurance claims from industrial organizations related to corresponding equipment damage.

Alarm management is the taming of an alarm system, changing it from a mixed alarm and awareness notification system with almost random priorities to a true operator support tool configured to notify operators to take the right actions at the right time to avoid undesired consequences. The primary function of the alarm management system is to ensure that control room operators, for example, are notified of an abnormal situation that requires actions to be taken to prevent or mitigate the potential consequences that could occur if the abnormal situation goes undetected. If the operator is unable to respond to the alarm in the required time to respond, the safety system may be initiated.

In some industries, there are standards and recommended practices (EEMUA 191 guidance, ISA 18.2 standard, IEC 62682 Standard, API RP1167, and the like) intended to provide guidance for configuring alarm management processes appropriately. The process industries are plagued by different kinds of alarm system issues such as nuisance alarms (chattering, stale), bad actors alarms, alarm floods, improper priority distribution, and the like. Thus, there is a constant need for performing what is known as an alarm rationalization exercise to make sure the alarm management system remains useful for the operation.

Rationalization of alarms may include tuning of alarm settings, priorities, alarm response details, and other alarm properties, which can prove an onerous task due to the sheer volume of tags in an alarm system.

Standards like ISA 18.2 recommend a management of change (MOC) process for any changes in the alarm management systems. This could include alarm system changes pertaining to the addition of new alarms, removal of existing alarms, alarm attribute modification, changes to alarm system functions, authorization, and documentation. The purpose of management of change is to ensure that changes are authorized and subjected to the evaluation criteria as per a pertinent alarm philosophy. The MOC process ensures that the appropriate lifecycle activities are applied to alarm system changes.

Different kinds of activities corresponding to alarm system modification may require different levels of management of change involvement/oversight/intervention. The addition or removal of alarms and the modification of specified attributes require one type of authorization through an MOC procedure. For example, permanent changes that result in a deviation from authorized values of an alarm setpoint, class, priority, consequence, setpoint rationale, suppression logic, or response time may require a different type of evaluation through the MOC procedure than the modification of specified attributes to different authorized values.

The purpose of MOC procedure is to ensure that the following considerations are addressed: the technical basis for the proposed change, the impact of change on health, safety, and the environment, modifications are in accordance with the alarm philosophy, modifications for operating procedures, time period(s) for which the change is valid, authorization requirements for the proposed change, maintenance of a degree of safety if the alarm is implemented for safety reasons, and personnel from appropriate disciplines are included in the review as necessary.

Thus, to address these and/or other issues related to such example solutions, example systems, apparatuses, methods, and computer program products for alarm system management are disclosed herein. For example, an embodiment, in this disclosure, described in greater detail below, includes a system that includes a computing device. In some embodiments, the computing device is configured to identify an alarm management system and a set of parameters corresponding to the alarm management system, wherein the set of parameters correspond to one or more types of changes to the alarm management system. In some embodiments, the computing device is configured to provide a platform via which a user can configure one or more management of change (MOC) workflows. In some embodiments, the computing device is configured to detect at least one change to the alarm management system. In some embodiments, the computing device is configured to determine at least one type of change corresponding to the detected at least one change to the alarm management system. In some embodiments, the computing device is configured to identify at least one MOC workflow corresponding to the at least one type of change. In some embodiments, the computing device is configured to generate one or more tasks corresponding to the identified at least one MOC workflow.

Accordingly, the systems, apparatuses, methods, and computer program products disclosed herein enable customizable alarm system management.

### Example Systems and Apparatuses

Embodiments of the present disclosure herein include systems, methods, and computer program products configured for customizing alarm management systems. It should be readily appreciated that the embodiments of the apparatus, systems, methods, and computer program product described herein may be configured in various additional and alternative manners in addition to those expressly described herein.

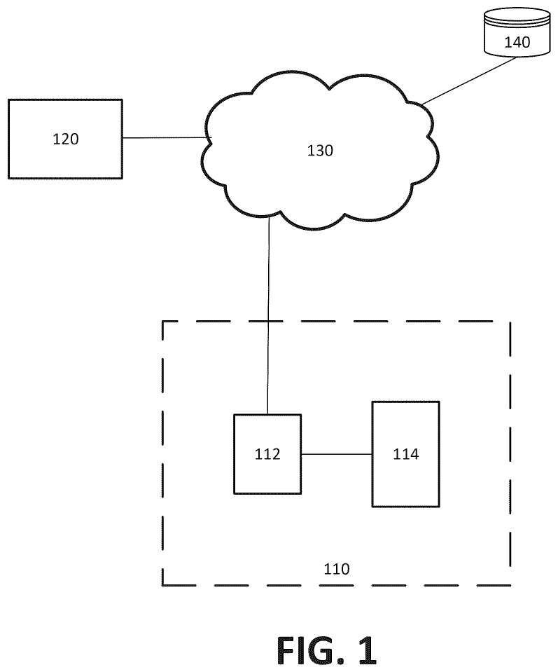

FIG. 1 illustrates an example block diagram of an environment 100 in which embodiments of the present disclosure may operate. As depicted, FIG. 1 includes a user device 110, one or more alarm systems 120, a network 130, and one or more databases 140. Environment 100 corresponds to an environment in which the methods as described herein may be executed.

In some embodiments, the environment 100 includes a computing device 110. The computing device 110 may be located remotely from one or more alarm systems 120 and the one or more databases 140. In this regard, for example, the computing device 110 may be located in a remote cloud server, for example, and electronically and/or communicatively coupled to any of the one or more alarm systems 120 and the one or more databases 140 via at least the network 130. In some embodiments, the computing device 110 is configured via hardware, software, firmware, and/or a combination thereof to perform data intake of one or more types of data, such as data received from the one or more alarm systems 120 and/or the one or more databases 140.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, computing device 110 is an alarm management system. As depicted, in some embodiments, computing device 110 includes application 112 and graphical user interface (GUI) 114. In some embodiments, the application 112 is configured to generate and/or transmit command(s) that control, adjust, or otherwise impact operations of the one or more alarm systems 120 and the one or more databases 140. For example, the application 112 may be configured to send instructions to one or more databases 140 to create a data library by storing one or more configured management of change (MOC) workflows. For example, in various embodiments, the computing device 110 and the application 112 may be configured to execute and/or perform one or more operations and/or functions described herein.

The one or more databases 140 may be configured to receive, store, and/or transmit data. For example, the one or more databases 140 may be configured to receive, store, and/or transmit data associated with the computing device 110 and/or the one or more alarm systems 120. In this regard, for example, the one or more databases 140 may be configured to receive, store, and/or transmit MOC workflow data, alarm system change types, MOC parameter data, and the like. The one or more databases 140 may be located remotely from computing device 110, in proximity of the computing device 110, and/or within the computing device 110. In some embodiments, the one or more databases 140 may be representative and/or indicative of an MOC information database.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the computing device 110 may include the one or more databases 140.

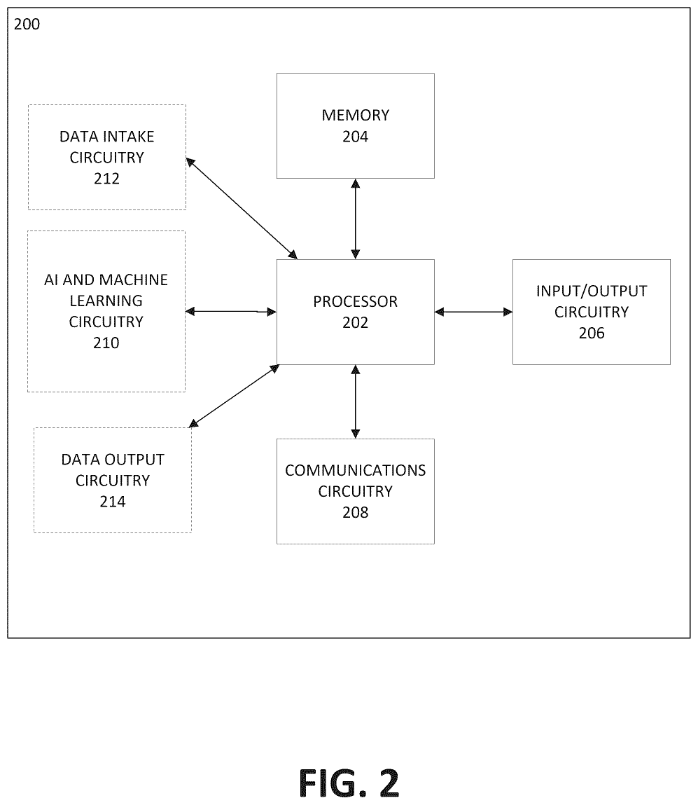

FIG. 2 illustrates an example block diagram of an example system that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, computing device 110, the one or more databases 140, and/or the one or more alarm systems 120. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, computing apparatus 200 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data from the one or more alarm systems 120. In some embodiments, the data intake circuitry 212 includes hardware, software, firmware, and/or a combination thereof, that retrieves particular data associated with the one or more alarm systems 120 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model. In at least some embodiments, AI and machine learning circuitry 210 may be configured to analyze known historical management of change (MOC) workflows and alarm system change types, and determine appropriate workflows and/or tasks corresponding to a received alarm system change based on the machine learning model and/or AI analysis.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

### Example Methods

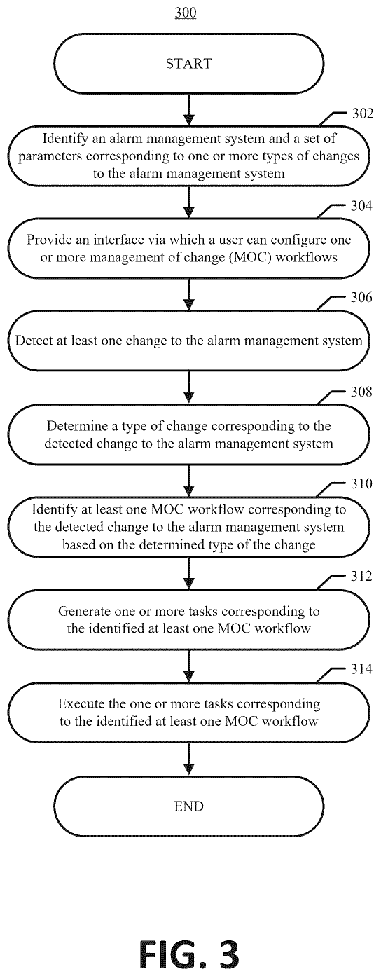

Referring now to FIG. 3, a flowchart providing an example method 300 is illustrated. In this regard, FIG. 3 illustrates operations that may be performed by the computing device 110, the one or more alarm systems 120, the one or more databases 140, and/or the like. In some embodiments, the example method 300 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 300.

As shown in block 302, the method 300 may include identifying an alarm management system and a set of parameters corresponding to one or more types of changes to the alarm management system. In some embodiments, the computing device 110 is configured to identify a subject alarm system controlled via an application (such as application 112) of computing device 110. In some embodiments, the computing device 110 is configured to receive connection details corresponding to the subject alarm system, such as the one or more alarm systems 120, from an external system. In some embodiments, the computing device 110 is operably connected to the alarm systems 120. In some embodiments, the computing device 110 is configured to identify a set of parameters corresponding to a set of standards or practices implemented with respect to the alarm one or more alarm systems 120. For example, the set of parameters may include parameters corresponding to requirements as indicated by a protocol or a set of standards. As discussed above, such a set of standards or protocols may be, but is not limited to, EEMUA 191 guidance, ISA 18.2 standard, ICE 62682 Standard, API RP1167 for Alarm Management, and the like. In general, the set of parameters may correspond to any set of policies, guidelines, or the like with which an alarm system, or an alarm management system, must adhere.

In at least some embodiments, the method 300 further includes enabling a user to define one or more parameters corresponding to one or more types of change corresponding to an alarm management system.

In at least some embodiments, the method 300 further includes enabling a user to define one or more parameters corresponding to categories for types of alarms. Types of alarms may include, but are not limited to alarms for normal operations, alarms related to safety identified by Hazard and Operability Analysis (HAZOP), Layer of Protection (LOP) Alarms, alarms used in Safety Integrity Level(SIL),. For example, the user may be able to define a first set of parameters which are applied to alarms of a first type, a second set of parameters which are applied to alarms of a second type, a third set of parameters which are applied to alarms of both the first type and the second type, and a fourth set of parameters which are applied to alarms of all types. The computing device 110 may additionally be configured to enable a user to define parameters for one or more specific alarm systems, such as the one or more alarm systems 120. In general, the computing device 110 may be configured to enable a user to define parameters, via user interface 114, for example, and assign those parameters to any number of alarm types or specific alarm systems. For example, the computing device 110 may enable the user to select one or more protocols or sets of guidelines to which an alarm system of the one or more alarm systems 120 must adhere.

As shown in block 304, the method 300 may include providing an interface via which a user can configure one or more management of change (MOC) workflows. In some embodiments, the computing device 110 is configured to enable a user to input configuration details corresponding to one or more management of change workflows. As used herein, MOC workflows generally correspond to workflows or processes implemented to ensure that environmental, health, and safety risks are evaluated and controlled prior to implementing changes to an alarm system, such that an operator can identify potential new hazards associated with the changes. In some embodiments, the computing device 110 is configured to define one or more steps for an MOC workflow corresponding to a change to the one or more alarm systems 120. In some embodiments, the steps of an MOC workflow may include, but are not limited to, any of recognizing proposed changes, evaluating hazards and risks associated with the changes, determining if the hazards and risks can be reduced, controlled, or eliminated, determining if the changes can or should be made, implementing the changes, training workers on the implemented changes, and following procedures associated with the implemented changes. In general, the computing device 110 may be configured to provide an interface via which a user can define or otherwise calibrate the steps of an MOC workflow corresponding to one or more types of changes to any number of alarm systems. Configuring one or more MOC workflows may include defining separate roles for proposing changes and approving changes, giving a role (such as a process engineer) the functionality to enforce alarm settings, defining which roles can propose changes, defining which roles can accept or reject changes, and defining which roles can review changes. For example, configuring one or more MOC workflows may include defining that, for permanent changes, only managers can approve or deny the changes, and only process engineers can ultimately enforce and implement proposed changes. In some embodiments, configuring one or more MOC workflows includes defining options for different levels and types of reviews and approvals corresponding to any change. In some embodiments, configuring one or more MOC workflows includes indicating that a user assigned to review or approve proposed changes may conduct said review or approval in parallel with other users or independent of other users. Configuring one or more MOC workflows may include defining a required number of reviewers or approvers. In some embodiments, a configured MOC workflow can have multiple levels of reviewers and approvers, such that a first level of reviewers must complete their review before a second level of approvers will begin the approval process. For example, a configured MOC workflow could have a 4 level mixed process with a 1^{st} level of multiple reviewers and 3 subsequent levels of approvers. In some embodiments, configuring an MOC workflow includes referencing an MOC workflow created and provided by an external system.

As used herein, “review” tasks may be tasks via a which a user can provide feedback, such as suggested edits or other alterations with respect to a proposed change. “Approval” tasks may be tasks by which a user can indicate either a rejection or an acceptance. In some embodiments, review tasks and approval tasks may be aggregated, such that a user can issue both feedback and approval/rejection responsive to a single task.

As shown in block 306, the method 300 may include detecting at least one change to the alarm management system. In some embodiments, the computing device 110 is configured to monitor the one or more alarm systems 120 for changes or proposed changes. In some embodiments, computing device 110 is configured to detect any changes proposed to the one or more alarm systems 120. In some embodiments, the computing device is configured to detect any changes implemented with respect to the one or more alarm systems 120. In general, detected changes may correspond to changes proposed or implemented at the one or more alarm systems 120 or via the computing device 110 configured to manage the one or more alarm systems 120. In some embodiments, the computing device 110 is configured to provide an interface via which changes to the one or more alarm systems 120 can be proposed. In some embodiments, detecting at least one change to the alarm management system includes receiving a notification of one or more proposed changes from an external system.

As shown in block 308, the method 300 may include determining a type of change corresponding to the detected change to the alarm management system. In some embodiments, the computing device 110 is configured to analyze the detected change to the alarm management system to determine a corresponding change type. In some embodiments, the computing device 110 is configured to compare one or more details of the detected change to the alarm management system to corresponding details of one or more historical changes. In such embodiments, the computing device 110 may be configured to determine a type of change corresponding to the detected change based on a similarity score relative to a historical change exceeding a selected threshold. For example, if one or more attributes of a historical change are comparable to one or more attributes of the detected change within a selected error threshold (5%, for example), the detected change may be determined to be the same type as the historical change.

As shown in block 310, the method 300 may include identifying at least one MOC workflow corresponding to the detected change to the alarm management system based on the determined type of the change. In some embodiments, the computing device 110 is configured to query a database, such as the one or more databases 140, to identify an appropriate workflow corresponding to the type of change associated with the detected change to the alarm management system. In general, the computing device 110 may be configured to identify an MOC workflow configured for use with respect to changes of the same type as the detected change to the alarm management system. In some embodiments, identifying at least one MOC workflow corresponding to the detected change includes recommending an MOC workflow or an MOC workflow type based on MOC workflows previously implemented relative to similar changes. In at least some embodiments, the computing device 110 is configured to identify at least one MOC workflow corresponding to the detected change to the alarm management system using a rule-based system or methodology. For example, the computing device 110 may be configured to leverage machine learning techniques to gradually identify appropriate MOC workflows for corresponding alarm management system change types. In at least some embodiments, such as embodiments wherein a simple change is proposed, computing device 110 may be configured to bypass identifying at least one MOC workflow corresponding to the detected change, as no MOC workflow may be required in cases where a change does not yield significant impacts. In such embodiments, the method 300 may conclude responsive to determining that the detected change is a simple change requiring no MOC workflows.

As shown in block 312, the method 300 may include generating one or more tasks corresponding to the identified at least one MOC workflow. In some embodiments, the computing device 110 is configured to generate one or more tasks associated with evaluating hazards and risks associated with the changes, determining if the hazards and risks can be reduced, controlled, or eliminated, determining if the changes can or should be made, implementing the changes, training workers on the implemented changes, and following procedures associated with the implemented changes. In some embodiments, the computing device 110 is configured to assign one or more users to each of the generated one or more tasks. In some embodiments, the computing device 110 is configured to notify one or more appropriate users when it is their turn to review or approve the detected change. In some embodiments, the computing device 110 is configured to send one or more reminder emails corresponding to one or more unattended reviews or approvals. In some embodiments, the computing device 110 is configured to identify one or more levels corresponding to review or approval requirements. In such embodiments, the computing device 110 may be configured to transition the MOC workflow from one level to the next based on satisfaction of requirements for each level. In some embodiments, the computing device 110 is configured to manage various tags that are participating in the MOC. As used herein, a “tag” may refer to a variable, point, parameter, or other measurement corresponding to the alarm system. Accordingly, as applied to an MOC workflow, a tag may indicate a measurement which, when measured/detected/identified within an alarm system/alarm management system, indicates/necessitates the use of the subject MOC workflow. For example, if a tag indicates a temperature threshold corresponding to an MOC workflow, then said workflow may be applied with respect to changes that are made when the system is subject to a temperature exceeding said threshold. In some embodiments, the computing device 110 is configured to define one or more modes of operation corresponding to the identified MOC workflow. For example, an MOC workflow may be identified as compatible with a system operating at 50% capacity; in such embodiments, the MOC workflow would be implemented responsive to changes proposed when the system is operating at 50% capacity, but that same MOC workflow may not be implemented responsive to changes proposed when the system is operating at 100% capacity. In some embodiments, the computing device 110 is configured to identify one or more next possible states, one or more internal states, and one or more end states corresponding to a current state. “States” as described herein refer to a current status of a proposed change; for example, a change which has cleared the requisite MOC workflow and been implemented could be considered to be in an “implemented” state. A change which has been rejected may be considered to be in a “rejected” state. A change which is proposed and currently awaiting user actions to proceed may be considered to be in a “pending” or “proposed” state. In some embodiments, the computing device 110 is configured to predict an estimated time of completion corresponding to the identified MOC workflow based on one or more previously completed MOC workflows. In some embodiments, the computing device 110 is configured to recommend an appropriate MOC workflow template. For example, an MOC workflow template may indicate an appropriate number of levels and types of reviews/approvals, etc. with respect to the corresponding change.

In at least some embodiments, the computing device 110 is additionally configured to validate assigned roles corresponding to the one or more generated tasks. In some embodiments, the computing device 110 is configured to check for authorization to ensure that only authorized roles or users have been assigned to review or approve the subject MOC workflow.

In at least some embodiments, the computing device 110 is additionally configured to provide one or more views by which a user can identify proposed changes, such as a view depicting before and after states corresponding to the changes. In some embodiments, the computing device 110 is configured to display a tag indicating one or more changes that a subject variable or workflow has undergone since a last approved version, such that a reviewer or approver can easily identify such changes.

As shown in block 314, the method 300 may include executing the one or more tasks corresponding to the identified at least one MOC workflow. In some embodiments, the computing device 110 is configured to execute some or all of the generated one or more tasks. In some embodiments, the computing device 110 is configured to cause execution of the tasks by an additional system, by sending instructions for execution of the tasks, for example. In general, executing the one or more tasks corresponding to the identified at least one MOC workflow includes ensuring execution of the generated one or more tasks, either via the computing device 110, the one or more alarm systems 120, the one or more databases 140, or any additional external systems configured to interact with the one or more alarm systems 120.

In at least some embodiments, the computing device 110 is configured to allow reviewers and/or approvers to provide or capture notes at a tag level or at an overall MOC level corresponding to the detected change to the alarm management system. For example, a user (reviewer or approver, in some embodiments) may provide notes with respect to an overall MOC workflow, or with respect to a single tag corresponding to the subject workflow. A tag level comment may be made available whenever a user views/interacts with the subject tag. In some embodiments, a tag level note or comment may indicate compliance details with respect to the corresponding tag. For example, a tag level note may indicate that a lack of compliance with a tag level requirement ultimately led to a rejection of an MOC workflow. An MOC level tag may indicate, for example, one or more conditions which have led to a proposed change being rejected. In some embodiments, MOC level notes indicate whether a change has been approved or rejected, while the corresponding tag level notes indicate compliance or rejection with respect to the corresponding tag. In some embodiments, the computing device 110 is configured to enable a user to record notes via a provided user interface to be displayed or distributed relative to a pertinent tag on the MOC workflow, or the MOC workflow itself.

In some embodiments, the computing device 110 is configured to allow one or more users to view and track the progress of the MOC workflow in terms of who has approved, rejected, or otherwise reviewed the MOC workflow. In general, the computing device 110 may be configured to track and display which of the generated one or more tasks have and have not been completed by an assigned user.

In at least some embodiments, such as simple cases corresponding to a rationalization exercise, the computing device 110 is configured to support a simple one click approval, and optionally capture notes that any corresponding changes were done as part of the subject rationalization exercise.

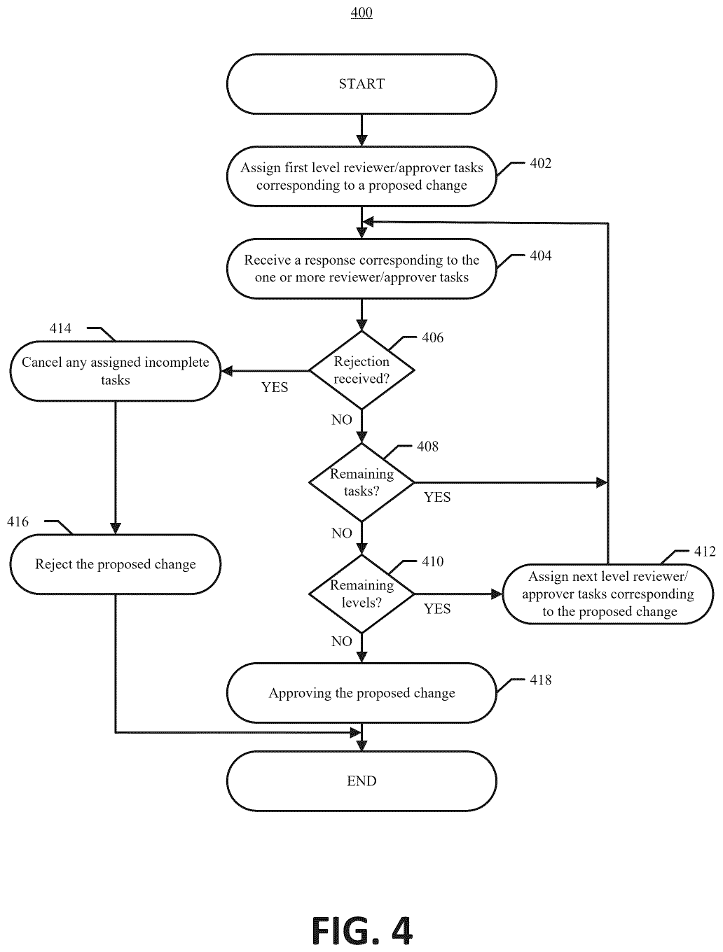

Referring now to FIG. 4, a flowchart providing an example method 400 is illustrated. In this regard, FIG. 4 illustrates operations that may be performed by the computing device 110, the one or more alarm systems 120, the one or more databases 140, and/or the like. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400.

As shown in block 402, the method 400 may include assigning first level reviewer/approver tasks corresponding to a proposed change. In some embodiments, the computing device 110 is configured to identify one or more one or more reviewer tasks and/or one or more approver tasks indicated by an MOC workflow corresponding to one or more proposed changes to an alarm management system. In some embodiments, the computing device 110 is configured to identify an appropriate MOC workflow corresponding to the proposed change. In such embodiments, the computing device 110 may process or otherwise follow the MOC workflow to identify one or more users as indicated by the MOC workflow who are responsible for the one or more reviewer tasks and/or the one or more approver tasks. In some embodiments, the computing device 110 is configured to provide a notification to the identified users (via email, for example) notifying said users of the approval/reviewer tasks to which they are assigned. In general, reviewer tasks refer to an assigned task to review and optionally provide feedback regarding a proposed change. Similarly, approval tasks refer to assigned tasks to approve a proposed change for implementation. In some embodiments, the assigned reviewer/approver tasks correspond to a first level of multiple levels of review/approval tasks.

As shown in block 404, the method 400 may include receiving a response corresponding to the one or more assigned reviewer/approver tasks. In some embodiments, the computing device 110 is configured to receive a user's review of the subject proposed change. In some embodiments, the computing device 110 is configured to receive a notification that a user has completed their assigned review. In some embodiments, the computing device 110 is configured to receive a notification that a user has completed their assigned approval. In general,

As shown in block 406, the method 400 may include determining whether a rejection has been received. In some embodiments, the computing device 110 is configured to analyze the response received corresponding to the one or more reviewer/approval tasks to determine whether the response corresponds to a rejection of the subject proposed change. If the computing device 110 determines that the received response corresponds to a rejection (406, yes branch), the method 400 continues by canceling (414) assigned incomplete tasks. If the computing device 110 determines that the received response does not correspond to a rejection (406, no branch), the method 400 continues by determining (408) whether any tasks remain.

As shown in block 408, the method 400 may include determining whether any tasks remain. In some embodiments, the computing device 110 is configured to determine whether any tasks remain incomplete. In some embodiments, the computing device 110 is configured to determine whether any review/approval tasks have been assigned that have not yet been completed. If the computing device 110 determines that no assigned tasks remain (408, no branch), the method 400 continues by determining (410) whether there are any remaining review/approval tasks. If the computing device 110 determines that one or more assigned tasks remain (408, yes branch), the method continues by returning to receiving (404) a response corresponding to the one or more reviewer/approver tasks.

As shown in block 410, the method 400 may include determining whether any levels remain. In some embodiments, the computing device 110 is configured to determine whether any additional levels of review or approval remain. For example, if the MOC workflow corresponding to the proposed change indicates multiple levels of review are required, the computing device 110 may be configured to determine whether all levels of review or approval are completed responsive to receipt of the most recent response. If the computing device 110 determines that one or more levels of review or approval remain (410, yes branch), the method continues by assigning (412) a next level of review/approval tasks corresponding to the proposed change. If the computing device 110 determines that no levels of review or approval remain (410, no branch), the method continues by approving (418) the proposed change.

As shown in block 412, the method 400 may include assigning next level reviewer/approver tasks corresponding to the proposed change. In some embodiments, the computing device 110 is configured to identify one or more one additional levels of one or more reviewer tasks and/or one or more approver tasks indicated by an MOC workflow corresponding to one or more proposed changes to an alarm management system. In some embodiments, the computing device 110 may process or otherwise follow the MOC workflow to identify one or more users as indicated by the MOC workflow who are responsible for the one or more additional levels of reviewer tasks and/or approver tasks. In some embodiments, the computing device 110 is configured to provide a notification to the identified users (via email, for example) notifying said users of the approval/reviewer tasks to which they are assigned. In general, reviewer tasks refer to an assigned task to review and optionally provide feedback regarding a proposed change. Similarly, approval tasks refer to assigned tasks to approve a proposed change for implementation.

As shown in block 414, the method 400 may include canceling any assigned incomplete tasks. In some embodiments, the computing device 110 is configured to identify any assigned tasks for which a response has not yet been received. In such embodiments, for such remaining tasks, the computing device 110 may provide a notification to the assigned users indicating that they no longer need to complete the subject task in light of the received rejection(s). In some embodiments, the computing device 110 may be configured to cancel or delete the tasks entirely, such that they are no longer available for interaction by the assigned user. In general, the computing device 110 may be configured to ensure that any unfinished tasks corresponding to the subject proposed change are canceled responsive to receipt of a rejection.

As shown in block 416, the method 400 may include rejecting the proposed change. In some embodiments, the computing device 110 is configured to issue a notification indicating that the proposed change has been rejected. In some embodiments, the computing device 110 is configured to remove the proposal corresponding to the proposed change and retain the current state of the alarm management system. In some embodiments, such as devices where a reviewer has provided comments/notes along with a rejection of the proposed change, rejecting the proposed change may additionally include providing a notification to the author of the proposed change including said comments/notes. In general, the computing device 110 may be configured to ensure that, responsive to a received rejection of the change, the change is not implemented.

As shown in block 418, the method 400 may include approving the proposed change. In some embodiments, the computing device 110 is configured to provide a notification indicating that the proposed change is approved for implementation. In some embodiments, the computing device 110 is configured to implement the change itself. In some embodiments, the computing device 110 is configured to notify a user responsible for implementing the change that the change has been approved.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

1. A method comprising:
identifying, by one or more processors, an alarm management system and a set of parameters corresponding to the alarm management system, wherein the set of parameters correspond to one or more types of changes to the alarm management system;
providing, by the one or more processors, a platform via which a user can configure one or more management of change (MOC) workflows;
detecting, by the one or more processors, at least one change to the alarm management system;
determining, by the one or more processors, at least one type of change corresponding to the detected at least one change to the alarm management system;
identifying, by the one or more processors, at least one MOC workflow corresponding to the at least one type of change; and
generating, by the one or more processors, one or more tasks corresponding to the identified at least one MOC workflow.

2. The method of claim 1, further comprising executing, by the one or more processors, the generated one or more tasks corresponding to the at least one MOC workflow.

3. The method of claim 2, wherein executing the generated one or more tasks comprises assigning, by the one or more processors, one or more reviewers to the at least one MOC workflow corresponding to the detected change to the alarm management system.

4. The method of claim 2, wherein the set of parameters includes one or more parameters directed towards one or more levels of review required with respect to the identified type of change corresponding to the detected at least one change to the alarm management system.

5. The method of claim 2, wherein executing the generated one or more tasks comprises assigning, by the one or more processors, one or more approvers to the at least one MOC workflow corresponding to the detected change to the alarm system.

6. The method of claim 2, wherein the set of parameters includes one or more parameters directed towards levels of approval required for the one or more types of changes to the alarm management system.

7. The method of claim 2, wherein generating at least one task corresponding to the at least one MOC workflow includes generating, by the one or more processors, a combination of one or more reviewer tasks and one or more approver tasks.

8. The method of claim 7, further comprising:
receiving a rejection responsive to a threshold number of the one or more reviewer tasks and the one or more approver tasks; and
canceling one or more additional tasks responsive to receiving a rejection corresponding to the threshold number of the one or more reviewer tasks and the one or more approver tasks.

9. The method of claim 1, wherein generating one or more tasks includes:
assigning the generated at least one task to a user; and
notifying the user that the generated at least one task is available for their interaction.

10. The method of claim 1, further comprising defining one or more proposal states which are supported by the alarm management system.

11. The method of claim 10, further comprising, defining, for a given current proposal state, one or more next possible states, wherein the next possible states are proposal states which are achievable upon completion of one or more currently assigned tasks.

12. The method of claim 1, further comprising:
determining, by the one or more processors, that the detected type of change corresponding to the change to the alarm management system is unknown; and
recommending, by the one or more processors, a potential type of change corresponding to the change of alarm management system based, at least in part, on historical change data.

13. The method of claim 1, further comprising predicting, by one or more processors, a time to completion for the at least one MOC workflow corresponding to the detected change to the alarm management system based, at least in part, on one or more previously completed MOC workflows.

14. The method of claim 1, wherein generating, by the one or more processors, at least one task corresponding to the at least one MOC workflow comprises identifying an appropriate template of tasks corresponding to the at least one MOC workflow.

15. The method of claim 1, further comprising applying, by one or more processors, one or more tags to the determined at least one MOC workflow, wherein the one or more tags indicate an alarm system measurement for which the determined at least one MOC workflow is appropriate.

16. A system comprising:
memory and one or more processors communicatively coupled to the memory, the one or more processors configured to:
identify an alarm management system and a set of parameters corresponding to the alarm management system, wherein the set of parameters correspond to one or more types of changes to the alarm management system;
provide a platform via which a user can configure one or more management of change (MOC) workflows;
detect at least one change to the alarm management system;
determine at least one type of change corresponding to the detected at least one change to the alarm management system;
identify at least one MOC workflow corresponding to the at least one type of change; and
generate one or more tasks corresponding to the identified at least one MOC workflow.

17. The system of claim 16, wherein the one or more processors are further configured to execute the generated one or more tasks corresponding to the at least one MOC workflow.

18. The system of claim 16, wherein the one or more processors are further configured to apply one or more tags to the determined at least one MOC workflow, wherein the one or more tags indicate an alarm system measurement for which the determined at least one MOC workflow is appropriate.

19. A computer program product comprising at least one non-transitory computer-readable storage medium having computer program code stored thereon that, in execution with at least one processor, configures the computer program product for:
identifying an alarm management system and a set of parameters corresponding to the alarm management system, wherein the set of parameters correspond to one or more types of changes to the alarm management system;
providing a platform via which a user can configure one or more management of change (MOC) workflows;
detect at least one change to the alarm management system;
determine at least one type of change corresponding to the detected at least one change to the alarm management system;
identify at least one MOC workflow corresponding to the at least one type of change; and
generating one or more tasks corresponding to the identified at least one MOC workflow.

20. The computer program product of claim 19, the at least one non-transitory computer-readable storage medium having computer program code stored thereon that, in execution with at least one processor, further configures the computer program product for executing the generated one or more tasks corresponding to the at least one MOC workflow.
